(19) United States
(12) Patent Application Publication
(10) Pub. No.: US 2016/0283582 A1
(43) Pub. Date: Sep. 29, 2016

(54) DEVICE AND METHOD FOR DETECTING SIMILAR TEXT, AND APPLICATION

(71) Applicants: Beijing Qihoo Technology Company Limited, Beijing (CN); Qizhi Software (Beijing) Company Limited, Beijing (CN)

(72) Inventors: Lin SUN, Beijing (CN); Peijun CHEN, Beijing (CN); Jisheng QIN, Beijing (CN)

(21) Appl. No.: 15/034,307

(22) PCT Filed: Sep. 23, 2014
(86) PCT No.: PCT/CN2014/087175

§ 371 Date: May 4, 2016

(30) Foreign Application Priority Data
Nov. 4, 2013 (CN) 201310537715.6
Nov. 4, 2013 (CN) 201310537962.6
Nov. 4, 2013 (CN) 201310537963.0
Nov. 4, 2013 (CN) 201310537964.5
Nov. 4, 2013 (CN) 201310537965.X

(51) Int. Cl. G06F 17/30; G06F 17/28; G06F 17/22; G06Q 50/00; G06Q 30/02

(52) U.S. Cl. CPC G06F 17/30684; G06Q 50/01; G06Q 30/0277; G06F 17/2223; G06F 17/2863

(57) ABSTRACT

Disclosed are a device and method for detecting a similar text, a device and method for recognizing advertisement features of messages issued in network games, a device and method for shielding advertisement content in a question and answer community, a device and method for recognizing advertisement messages in instant messaging, and a device and method for processing contents issued in a social network. The device and method for detecting a similar text are used for recognizing the similar text. The method for detecting a similar text comprises: processing a text to be detected, so as to acquire a Chinese text; converting Chinese characters in the acquired Chinese text into Pinyin so as to obtain a Pinyin text; extracting the feature of the Pinyin text, and forming a feature vector of the Pinyin text by the extracted feature; and according to the feature vector, judging whether the text to be detected matches a record in a database. The device and method for detecting a similar text of the present invention can reach the beneficial effects of reducing the operation amount and accurately recognizing the variation of the similar text.

### TECHNICAL FIELD

The present invention relates to the field of computer, in particular relates to a device and method for detecting a similar text, a device and a method for recognizing advertisement features of messages issued in network games, a device and a method for shielding advertisement contents in a question and answer community, a device and a method for recognizing advertisement messages in instant messaging and a device and a method for processing contents issued in a social network.

### DESCRIPTION OF RELATED ART

Along with the rise of network applications such as question and answer community, a large number of texts appear on the network, such as questions and answers of users. However, a large number of advertisement information is flooded in the network applications, which causes a lot of inconvenience for the users when searching for information while reduces the qualities of the network applications as well. In order to solve this problem, research works for computing text similarity are gradually developed, so as to expect that junk information such as advertisements can be found by calculating the text similarity.

There is a similar text detection method in which: first, features of text are extracted (for example, word segmentations are performed for the text and entity words are extracted) and the features are extended by using a variety of techniques (for example, words are extended by using a knowledge base such as synonyms dictionary and near synonyms dictionary) and the text is described by using a VSM model (for example, a text is represented as a vector by using the VSM model), then the texts are clustered by using a clustering method (for example, for two texts, after being subjected to vectorization representation, angle of cosines of two vectors is computed for characterizing similarity of the two texts and if the similarity is larger than a certain threshold, it is considered that the two text are similar) and the texts clustered together are similar.

However, in the network applications, there are a large number of variations of similar texts such as use of traditional Chinese characters, use of Pinyin instead of Chinese characters, use of characters with the same pronunciation instead of the original characters, adding a large number of disturbing characters without meanings and so on. The above technique has the following drawbacks: (I) there are errors in the results of the word segmentations; (II) the texts using different characters with the same pronunciation cannot be determined as similar; (III) two texts which are converted into Pinyin cannot be recognized as similar texts; (IV) computational complexity for the texts is too high (for example, it needs a larger amount of computation to represent the texts as a vector), so that the requirement of real-time computation in the current case of a large amount of data cannot be met.

### BRIEF SUMMARY OF THE INVENTION

In view of the above problems, the present invention is proposed so as to provide a device and method for detecting a similar text, a device and a method for recognizing advertisement features of messages issued in a network game, a device and a method for shielding advertisement contents in a question and answer community, a device and a method for recognizing advertisement messages in instant messaging and a device and a method for processing contents issued in a social network to overcome the above problems or at least partially solve the above problems.

In accordance with an aspect of the present invention, a device for detecting a similar text is provided, wherein the device includes: a Chinese text acquisition unit configured to process a text to acquire a Chinese text; a Pinyin text acquisition unit configured to convert Chinese characters in the acquired Chinese text into Pinyin so as to obtain a Pinyin text; a fingerprint acquisition unit configured to extract features of the Pinyin text and form a feature vector of the Pinyin text by the extracted features; a detection unit configured to, according to the feature vector, determine whether the text to be detected matches a record in a database.

In accordance with another aspect of the present invention, a device for recognizing advertisement features of messages issued in a network game is provided, including: a detection unit configured to detect a message issuing event at a game client; a text acquisition unit configured to acquire an issued message text according to the message issuing event; a feature vector extraction unit configured to extract one or more feature vectors included in the issued message text; a recognition unit configured to, according to the feature vector(s), recognize whether the issued message text to be detected matches one or more records in an advertisement feature database; a shielding unit configured to, once the recognition unit recognizes the above match, shield the message issuing event.

In accordance with another aspect of the present invention, a device for shielding advertisement contents in a question and answer community is provided, including: a text acquisition unit configured to receive a text to be questioned/an answer text edited by a poster in a question and answer community; a feature vector extraction unit configured to extract one or more feature vectors included in the text to be questioned/the answer text; a recognition unit configured to, according to the feature vector(s), recognize whether the text to be questioned/the answer text matches one or more records in an advertisement feature database; a shielding unit configured to, once the recognition unit recognizes the above match, shield the text to be questioned/the answer text as advertisement contents.

In accordance with another aspect of the present invention, a device for recognizing advertisement messages in instant messaging is provided, including: a text acquisition unit configured to detect text fields in an instant message sent from an instant messaging client; a feature vector extraction unit configured to extract one or more feature vectors included in the text fields; a recognition unit configured to, according to the feature vector(s), recognize the instant message matching an advertisement message.

In accordance with another aspect of the present invention, a device for processing contents issued in a social network is provided, including: a content acquisition unit configured to receive contents to be issued in a social network by a poster; a feature vector extraction unit configured to detect text fields in the contents to be issued to extract one or more feature vectors included in the text fields; a recognition unit configured to, according to the feature vector(s), recognize whether the text fields match one or more records in an advertisement feature database; a shielding unit configured to, once the recognition unit recognizes the above match, shield the contents to be issued as advertisement contents.

In accordance with another aspect of the present invention, a similar text detection method is provided, wherein the method includes the following steps: processing a text to be detected to acquire a Chinese text; converting Chinese characters in the acquired Chinese text into Pinyin to obtain a Pinyin text; extracting features of the Pinyin text and forming the extracted features into a feature vector of the Pinyin text; determining, according to the feature vector, whether the text to be detected matches a record in a database.

In accordance with another aspect of the present invention, a method for recognizing advertisement features of messages issued in a network game is provided, including: detecting a message issuing event at a game client; acquiring an issued message text according to the message issuing event; extracting one or more feature vectors included in the issued message text; recognizing, according to the feature vector(s), whether the issued message text to be detected matches one or more records in an advertisement feature database; shielding the message issuing event, once recognizing the above match.

In accordance with another aspect of the present invention, a method for shielding advertisement contents in a question and answer community is provided, including: receiving a text to be questioned/an answer text edited by a poster in a question and answer community; extracting one or more feature vectors included in the text to be questioned/the answer text; recognizing, according to the feature vector(s), whether the text to be questioned/the answer text matches one or more records in an advertisement feature database; shielding the text to be questioned/the answer text as advertisement contents, once recognizing the above match.

In accordance with another aspect of the present invention, a method for recognizing advertisement messages in instant messaging is provided, including: detecting text fields in an instant message sent from an instant messaging client; extracting one or more feature vectors included in the text fields; recognizing, according to the feature vector(s), the instant message matching an advertisement message.

In accordance with another aspect of the present invention, a method for processing contents issued in a social network is provided, including: receiving contents to be issued in a social network by a poster; detecting text fields in the contents to be issued to extract one or more feature vectors included in the text fields; recognizing, according to the feature vector(s), whether the text fields matches one or more records in an advertisement feature database; shielding the contents to be issued as advertisement contents, once the above match is recognized.

The similar text detection device and method according to the present invention can obtain a Chinese text from a text to be detected, to further obtain a Pinyin text so as to form a feature vector of the Pinyin text, and determine, according to the feature vector, whether the text to be detected matches a record in a database, so that the problems of a large amount of computation and being not capable of effectively recognizing the variations of the similar texts in the background art are solved and the beneficial effects of reducing the amount of the computation and accurately recognizing the variations of the similar texts are achieved. The device and the method for recognizing advertisement features of messages issued in a network game according to the present invention can accurately recognize the advertisement features of the messages issued in a network game. The device and the method for shielding advertisement contents in a question and answer community according to the present invention can accurately recognize the advertisement in the text to be questioned/of answers. The device and the method for recognizing advertisement messages in instant messaging according to the present invention effectively recognize the advertisement in the instant messaging and can perform corresponding management of shielding or banning to post. The device and the method for processing contents issued in a social network according to the present invention can recognize the advertisement contents from the contents to be issued by the poster in the social network and shield the corresponding contents to be issued.

The above explanation is merely an outline of the technical solution of the present application. In order to be able to understand the technical means of the present application more clearly and to be able to implement it in accordance with the contents of the specification, and in order to enable the above and other objects, features and advantages of the present application more evident and comprehensible, the specific embodiments of the present application are particularly described in the following.

### BRIEF DESCRIPTION OF THE SEVERAL VIEWS OF THE DRAWINGS

By reading the following detailed description of the preferred embodiments, various other advantage and benefits will be clear for those ordinary skilled in the art. The drawings are merely used for purpose of illustration of the preferred embodiments and are not considered as limiting of the present application. Further, the same components will be denoted by the same reference symbol throughout the drawings. In the drawings:

FIG. 1 illustrates a flowchart of a similar text detection method according to an embodiment of the present invention;

FIG. 2 illustrates a detailed flowchart of a step S100, a step S200 and a step S300 as shown in FIG. 1;

FIG. 3 illustrates a detailed flowchart of a step S400 as shown in FIG. 1;

FIG. 4 illustrates a block diagram of a similar text detection device according to an embodiment of the present invention;

FIG. 5 illustrates a flowchart of a method for recognizing advertisement features of messages issued in a network game according to an embodiment of the present invention;

FIG. 6 illustrates a block diagram of a device for recognizing advertisement features of messages issued in a network game according to an embodiment of the present invention;

FIG. 7 illustrates a flowchart of a method for shielding advertisement contents in a question and answer community according to an embodiment of the present invention;

FIG. 8 illustrates a block diagram of a device for shielding advertisement contents in a question and answer community according to an embodiment of the present invention;

FIG. 9 illustrates a flowchart of a method for recognizing advertisement messages in instant messaging according to an embodiment of the present invention;

FIG. 10 illustrates a block diagram of a device for recognizing advertisement messages in instant messaging according to an embodiment of the present invention;

FIG. 11 illustrates a flowchart of a method for processing contents issued in a social network according to an embodiment of the present invention; and

FIG. 12 illustrates a block diagram of a device for processing contents issued in a social network according to an embodiment of the present invention;

FIG. 13 illustrates a block diagram of an application server for executing the methods according to the present invention; and

FIG. 14 illustrates a storage unit for holding or carrying program codes realizing the methods according to the present invention.

### DETAILED DESCRIPTION OF THE INVENTION

Below, the exemplary embodiments of the present disclosure will be described further in detail with reference to the drawings. Although the exemplary embodiments of the present disclosure are showed in the drawings, it is to understand that, the present disclosure can be implemented in various forms and shall not be limited by the embodiments here set forth. In contrary, these embodiments are provided in order to be able to understand the present disclosure more thoroughly and to be able to transfer the scope of the present disclosure fully to those skilled in the art.

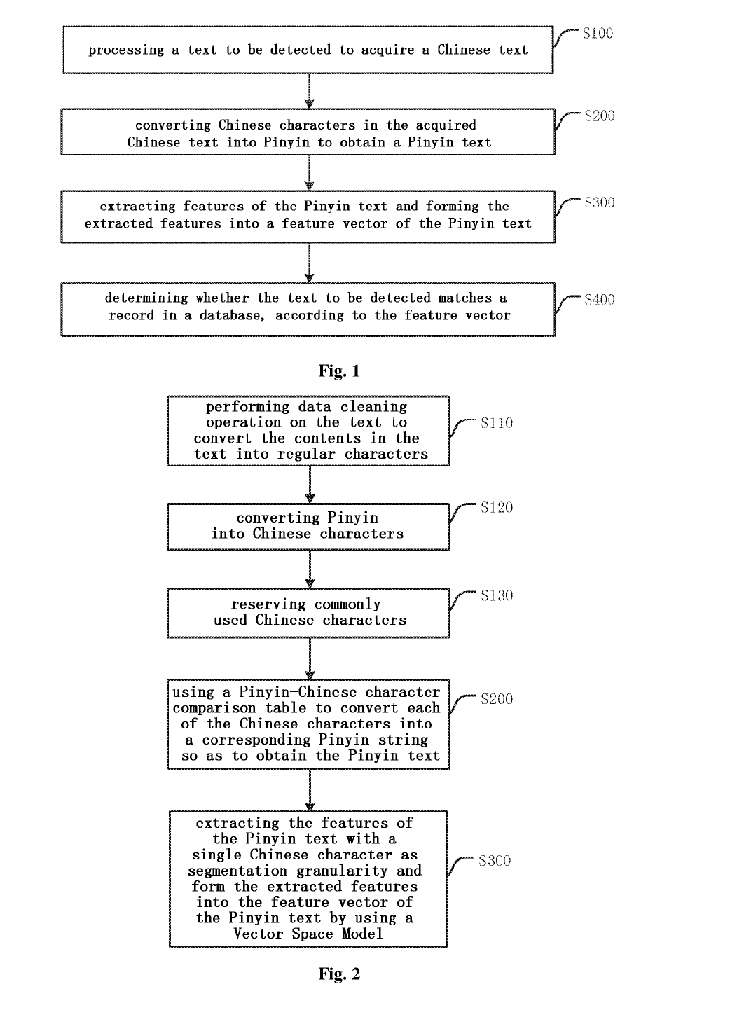

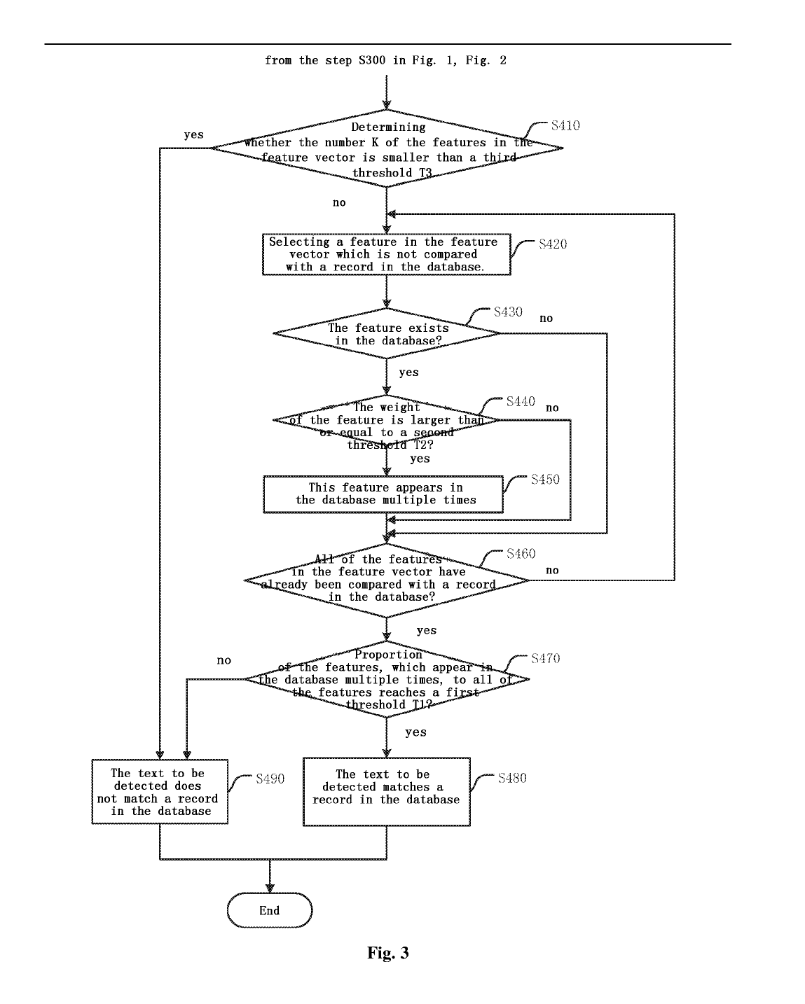

FIG. 1 illustrates a flowchart of a similar text detection method according to an embodiment 7of the present invention. FIG. 2 illustrates a detailed flowchart of a step S100, a step S200 and a step S300 in FIG. 1. The method includes the following steps S100, S200, S300 and S400.

S100: processing a text to be detected, to acquire a Chinese text.

By acquiring the Chinese text from the text to be detected, influence of variations of the similar texts including disturbing characters without meanings, traditional Chinese characters etc., on the similar text detection method of the present embodiment can be eliminated.

S200: converting Chinese characters in the acquired Chinese text into Pinyin to obtain a Pinyin text.

By converting the Chinese characters in the Chinese text uniformly into Pinyin, the influence of the variations of the similar texts such as replacing the Chinese characters with the Pinyin, replacing original words with the words with the same pronunciation, etc., on the similar text detection method of the present embodiment can be eliminated.

S300: extracting features of the Pinyin text and forming the extracted features into a feature vector of the Pinyin text.

In the present embodiment, an N-gram language model can be adopted to extract the feature vector of the Pinyin text. Based on granularity of the Chinese characters in the Chinese text acquired in the step S100, for the Pinyin text acquired in the step S200, N-gram features SHINGLE₁, SHINGLE₂, SHINGLEₘ are extracted. For example, if the Chinese text acquired in the step S100 is “ [symbol] ”, the granularity of the Chinese characters is “ [symbol] ”, “ [symbol] ”, “ [symbol] ”, “ [symbol] ”, “ [symbol] ”, “ [symbol] ”, “ [symbol] ”, and the Pinyin text acquired in the step S200 is “wo ai bei jing tian an men”, then the Pinyin string is segmented into “wo”, “ai”, “bei”, “jing”, “tian”, “an”, “men”. If let N=6, then in the step S300, the acquired N-gram feature SHINGLE₁ is “wo ai bei jing tian an”, SHINGLE₂ is “ai bei jing tian an men”, and the like. And a VSM (Vector Space Model) is used to form the feature vector D=<SHINGLE₁, SHINGLE₂, SHINGLEₘ>.

S400: according to the feature vector, determining whether the text to be detected match a record in a database.

In the present embodiment, for each feature, it will be detected whether the feature appears in a preset database a plurality of times. After all of the features in a feature vector are detected, proportion of the features in the feature vector, which appear in the database a plurality of times, to all of the features of the feature vector is determined, so as to determine whether the text to be detected matches a record in the database. In the present embodiment, a Redis database is used as the preset database. It is possible to obtain massive features by analyzing massive network texts (for example fetching junk information such as collected network advertisements) and obtain weights by accounting the numbers of the obtained respective features and make the features (Shingle) and the weights (Value) constitute the database.

FIG. 2 illustrates a detailed flowchart of the step S100, the step S200 and the step S300 in FIG. 1. The step S100 includes specifically:

S110: performing data cleaning operation on the text to convert the contents in the text into regular characters.

Wherein performing data cleaning operation on the text specifically includes: recognizing and discarding HTML marks, converting traditional Chinese characters into simplified Chinese characters, converting full-width characters into half-width characters, converting uppercase English letters into lowercase English letters and recognizing and discarding url.

S120: converting the Pinyin into Chinese characters.

Wherein converting the Pinyin in the text into Chinese characters specifically includes: converting the Pinyin in the text into Chinese characters by using a bidirectional maximum matching algorithm and if one Pinyin corresponds to a plurality of Chinese characters, selecting any one from the corresponding plurality of Chinese characters.

S130: reserving commonly used Chinese characters.

Wherein reserving commonly used Chinese characters specifically includes: filtering the text by using the commonly used Chinese characters in the GBK coding table, discarding all characters which do not belong to the commonly used Chinese characters, that is, only reserving Chinese characters in 0xB0A0˜0xF7FE of GBK coding of Chinese characters.

The step S200 specifically includes: using a Pinyin-Chinese character comparison table to convert each of the Chinese characters into a corresponding Pinyin string, so as to obtain the Pinyin text.

By acquiring the Chinese text from the text to be detected in the step S100 and by converting the Chinese characters in the acquired Chinese text into the Pinyin to obtain the Pinyin text in the step S200, different variations of similar texts can be recognized as the same Pinyin text. For example, from the text and three variations as shown in Table 1, the same Pinyin text is obtained thought the steps S100 and S200.

TABLE 1
Text and Three Variations

| | |
|---|---|
| The original text | [symbol] → www.ur17.me/0wdf [symbol] [symbol] [symbol] [symbol] |
| | →www.url7.me/egkf [symbol] [symbol] [symbol] |
| Variation 1: different | [symbol] → Www.URl7.Me/OwDf [symbol] [symbol] [symbol] [symbol] |
| characters with the | [symbol] → www.URL7.ME/eGKf [symbol] [symbol] [symbol] |
| same pronunciation | |
| Variation 2: replacing | [symbol] mao [symbol] → Www.URl7.Me/OwDf [symbol] [symbol] liu [symbol] [symbol] [symbol] |
| Chinese characters | [symbol] chaoshi→ www.URL7.ME/eGKf [symbol] [symbol] lan [symbol] [symbol] |
| with Pinyin | |
| Variation 3: adding | 1x3f [symbol] → Www.URl7.Me/OwDf [symbol] [symbol] [symbol] |
| disturbing characters | $TFA [symbol] mao [symbol] → www.URL7.ME/eGKf [symbol] [symbol] &amp;nbsp; [symbol] |
| | [symbol] [symbol] sdjH |

By respectively processing the above original text and three variation by using the step S100 and the step S200 of the present invention, the same Pinyin text can be obtained: “tian mao shou ye zhan tie dao liu lan qi fang wen tian mao chao shi zhan tie dao liu lan qi fang wen”. Exemplifying Variation 3: the text after being subjected to data cleaning in the step S110 is: “1x3f [symbol] [symbol] tfa [symbol] mao [symbol] [symbol] sdjh”, converting the Pinyin into Chinese characters, the result of converting the Pinyin into Chinese characters in the step S120 is: “1x3f [symbol] [symbol] tfa [symbol] [symbol] sdjh” in which “1x3f”, “tfa” and “sdjh” are not processed because they are not in the Pinyin dictionary, and because “mao” is in the Pinyin dictionary, a Chinese character “ [symbol] ” is randomly selected for replacing it; after reserving the commonly used Chinese characters in the step S130, the result is: “ [symbol] [symbol] [symbol] ” and the Pinyin-Chinese character comparison table is further used to convert each of the Chinese characters into the corresponding Pinyin, then the above Pinyin text is obtained. From the original text, Variation 1 and Variation 2, the same Pinyin text can also be obtained.

When N=6, the feature vector obtained through the step S300 is <tian mao shou ye zhan tie, mao shou ye zhan tie dao, shou ye zhan tie dao liu, ye zhan tie dao liu lan, zhan tie dao liu lan qi, tie dao liu lan qi fang, dao liu lan qi fang wen, liu lan qi fang wen tan, lan qi fang wen tan mao, qi fang wen tan mao chao, fang wen tan mao chao shi, wen tan mao chao shi zhan, tan mao chao shi zhan tie, mao chao shi zhan tie dao, chao shi zhan tie dao liu, shi zhan tie dao liu lan, zhan tie dao liu lan qi, tie dao liu lan qi fang, dao liu lan qi fang wen>.

FIG. 3 illustrates a detailed flowchart of the step S400 in FIG. 1. For each feature vector acquired by the above step S300, the step S400 specifically includes the following steps:

S410: determining whether the number K of the features in the feature vector is smaller than a third threshold T3, if yes, then a step S490 is executed; and if no, then a step S420 is executed. The operation of this step has at least two advantages. First, in an actual Internet forum, the length of the junk text such as advertisement is often not too short and a considerable amount of texts in the forum are texts with a very small length (for example not more than three Chinese characters), therefore through the determination in this step, it is made no longer to perform the determination in steps S420-S470 as to a feature vector with a text of a small length (the number of the acquired features is smaller than a preset threshold), which reduces the amount of computation of the method of the present embodiment; second, the text length of the text is small, therefore the number of the features is small, and it can be known from the following step S470 that, for the text, there is probability of being misjudged as matching the record in the database because a few features appear in the database, and through the step S410, this misjudging is avoided.

S420: selecting a feature (Shingle) in the feature vector which is not compared with a record in the database.

S430: determining whether the feature acquired in the step S420 exists in the database, if so, then a step S440 is executed, and if not, then a step S460 is executed.

S440: determining whether the weight of the feature in the database is larger than or equal to a second threshold T2, if so, then a step S450 is executed, and if not, then a step S460 is executed.

S450: determining that this feature appears in the database multiple times and the step S460 is executed. Because it has been already determined in the step S440 that the weight is larger than or equal to the second threshold T2, it is determined in the step S450 that this feature appears in the database multiple times.

S460: determining whether all of the features in the feature vector have already been compared with a record in the database. If so, then a step S470 is executed, otherwise it is returned to execute a step S420, in which a feature which is not compared with a record in the database is read. Then for each feature of the feature vector, the step S430 will be executed.

S470: determining whether proportion of the features in the feature vector, which appear in the database multiple times, to all of the features of the feature vector reaches a first threshold T1. If yes, then a step S480 is executed, otherwise a step S490 is executed. In the present embodiment, by determining the proportion of the features in a feature vector, which appear in the database multiple times, to all of the features of the feature vector, it is reflected whether the text to be detected matches a record in the database. It can be known from the above, the computation methods adopted in the present embodiment all belong to simple text converting operations and simple data comparison operations and the relationship between the amount of computation and the length of the text is roughly a linear relationship of first order, so that computation overhead is small.

S480: determining that the text to be detected matches a record in the database and ending the determination operation.

S490: determining that the text to be detected does not match a record in the database and ending the determination operation.

Preferably, when it is determined in the step S480 that the text to be detected matches a record in the database, the method of the present embodiment further includes: for each feature in the feature vector, if it is detected that this feature exists in the database, the weight of this feature in the database is increased by 1. In other words, if the text to be detected matches a record in the database, the database Redis is updated, so that while the method of the present invention is used, the update of the database is realized.

Continuing to exemplify the feature vector acquired from the texts in Table 1, when N=6, the feature vector obtained through the step S300 is <tian mao shou ye zhan tie, mao shou ye zhan tie dao, shou ye zhan tie dao liu, ye zhan tie dao liu lan, zhan tie dao liu lan qi, tie dao liu lan qi fang, dao liu lan qi fang wen, liu lan qi fang wen tan, lan qi fang wen tan mao, qi fang wen tan mao chao, fang wen tan mao chao shi, wen tan mao chao shi zhan, tan mao chao shi zhan tie, mao chao shi zhan tie dao, chao shi zhan tie dao liu, shi zhan tie dao liu lan, zhan tie dao liu lan qi, tie dao liu lan qi fang, dao liu lan qi fang wen>. First, through the step S410, it is determined whether the number K=24 of the features in the feature vector is smaller than the third threshold T3. Assuming the third threshold T3=10, then K>T3. Further through the step S420, a feature is selected which is not compared with a record in the database, such as “tian mao shou ye zhan tie”. Through the step S430, it is determined whether this feature exists in the database. If it is determined that this feature does not exist in the database, then it is returned through the step S460 to the step S420 to select another feature. If it is determined in the step S430 that this feature exists in the database, then it is determined through the step S440 whether the weight Value of this feature in the database is larger than or equal to the second threshold T2. Assuming the weight Value=6 and the second threshold T2=2, then it is determined through the step S450 that this feature appears in the database multiple times. Preferably, the operation result of this step can be recorded by various ways such as marking the feature or recording the feature through a table. If all of 24 features have been determined (at least through the step S420 and the step S430), then the step S470 is executed, in which it is determined whether the proportion of the features, which appear in the database multiple times, to the above 24 features reaches the first threshold T1. Assuming the number of the features which appear in the database multiple times is 12, then the proportion of these features to the above 24 feature is 50%. Assuming the first threshold T1 is 30%, then it is determined that the text to be detected matches a record in the database and the determination operation ends.

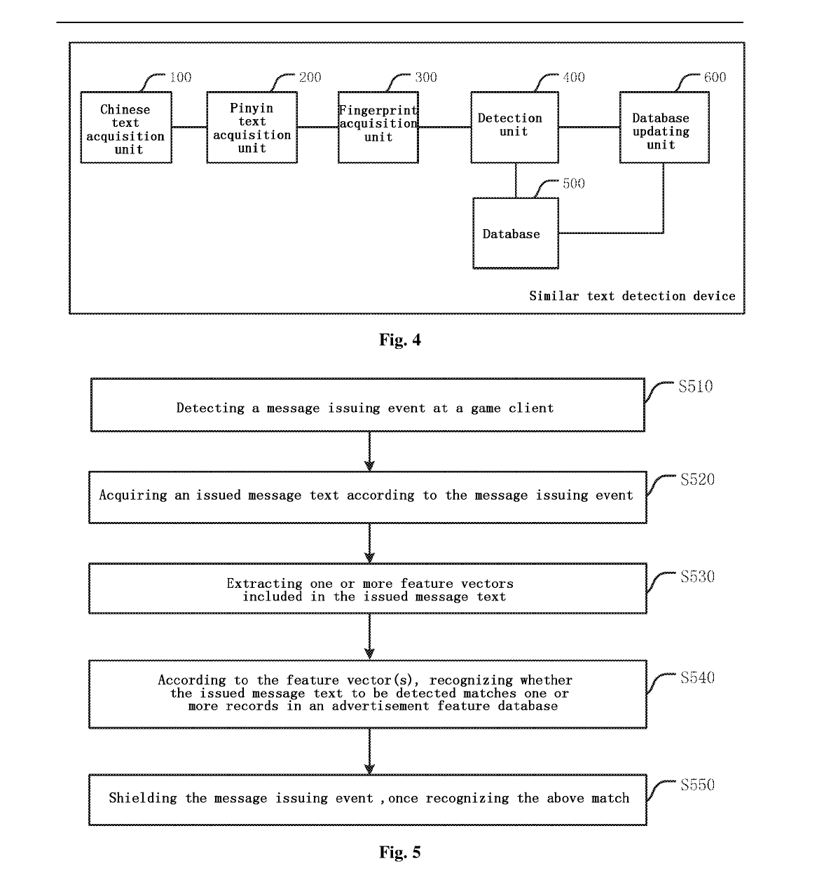

FIG. 4 illustrates a block diagram of a similar text detection device according to an embodiment of the present invention. The device includes a Chinese text acquisition unit 100, a Pinyin text acquisition unit 200, a fingerprint acquisition unit 300, a detection unit 400 and a database 500.

Wherein the Chinese text acquisition unit 100 is configured to process the text to acquire the Chinese text.

More specifically, the Chinese text acquisition unit 100 is configured to perform data cleaning operation on the text, the data cleaning operation including: recognizing and discarding HTML marks, converting traditional Chinese characters into simplified Chinese characters, converting full-width characters into half-width characters, converting uppercase English letters into lowercase English letters and recognizing and discarding url, to convert the contents in the text into regular characters; the Chinese text acquisition unit 100 is further configured to convert the Pinyin into Chinese characters, including: converting the Pinyin in the text into Chinese characters by using a bidirectional maximum matching algorithm and if one Pinyin corresponds to a plurality of Chinese characters, selecting any one from the corresponding plurality of Chinese characters to convert the Pinyin in the text into Chinese characters; the Chinese text acquisition unit 100 is further configured to reserve commonly used Chinese characters, including: filtering the text by using the commonly used Chinese characters in the GBK coding table, discarding all characters which do not belong to the commonly used Chinese characters, that is, only reserving Chinese characters in 0xB0A0˜0xF7FE of GBK coding of Chinese characters, to reserve commonly used Chinese characters.

The Pinyin text acquisition unit 200 is configured to convert the Chinese characters in the acquired Chinese text into Pinyin so as to obtain the Pinyin text, including: using a Pinyin-Chinese character comparison table to convert each of the Chinese characters into a corresponding Pinyin string, so as to obtain the Pinyin text.

By acquiring the Chinese text from the text to be detected by the Chinese text acquisition unit 100 and by converting the Chinese characters in the acquired Chinese text into Pinyin to obtain the Pinyin text by the Pinyin text acquisition unit 200, different variations of similar texts can be recognized as the same Pinyin text.

The fingerprint acquisition unit 300 is configured to extract features of the Pinyin text and form the extracted features into a feature vector of the Pinyin text. Specifically, the fingerprint acquisition unit 300 is configured to extract the features of the Pinyin text with a single Chinese character as segmentation granularity and form the extracted features into the feature vector of the Pinyin text by using the Vector Space Model. Preferably, the fingerprint acquisition unit 300 adopts the N-gram language model (N-gram) to extract the feature vector of the Pinyin text, and based on granularity of the Chinese characters in the Chinese text acquired by the Chinese text acquisition unit 100, for the Pinyin text acquired by the Pinyin text acquisition unit 200, extracts the N-gram features SHINGLE₁, SHINGLE₂, . . . , SHINGLEₘ. And the Vector Space Model is used to form the feature vector D=<SHINGLE₁, SHINGLE₂, SHINGLEₘ>.

The detection unit 400 is configured to, according to the feature vector, determine whether the text to be detected match a record in the database 500. A Redis database is used as the database 500 in the present embodiment. It is possible to obtain massive features by analyzing massive network texts (for example fetching junk information such as collected network advertisements) and obtain weights by accounting the numbers of the obtained respective features and make the features (Shingle) and the weights (Value) constitute the database.

Specifically, the detection unit 400 is configured to, for each feature in the feature vector, detect whether the feature appears in the database 500 a plurality of times. Specifically, the detection unit 400 is configured, for each feature in the feature vector, to search the database 500 to find whether the feature exists, if the feature exists, then further to look for the weight of the feature, and if the weight of the feature is larger than or equal to the preset second threshold T2, then to determine that the feature appears in the database 500 a plurality of times.

The detection unit 400 is further configured to determine whether proportion of the features in the feature vector, which appear in the database 500 multiple times, to all of the features of the feature vector reaches the first threshold T1. If so, then it is determined that the text to be detected matches a record in the database 500, otherwise does not match.

Further, the detection unit 400 is configured to, for each feature in the feature vector, before detecting whether the feature exists in the database 500, determine whether the number of the features in the feature vector is smaller than the third threshold T3. If so, then the text to be detected does not match a record in the database 500 and the determination operation ends. Otherwise, further for each feature in the feature vector, detect whether the feature appears in the database 500 multiple times.

Preferably, the similar text detection device of the present embodiment further includes a database updating unit 600.

The database updating unit 600 is configured to, when it is determined that the text to be detected matches a record in the database 500, for each feature in the feature vector, if it is detected that the feature exists in the database 500, increase the weight of this feature in the database 500 by 1. In other words, if the text to be detected matches a record in the database, the database 500 is updated, so that the update of the database 500 is realized.

FIG. 5 illustrates a flowchart of a method for recognizing advertisement features of messages issued in a network game according to an embodiment of the present invention. The method includes the following steps S510, S520, S530, S540 and S550.

S510: detecting a message issuing event at a game client.

Specifically, when a message is issued at the game client, a message issuing event can be detected. Further, the message issuing event can be detected by detecting communication contents between the game server and the game client.

S520: acquiring an issued message text according to the message issuing event. It can be easily understood by those skilled in the art that the issued message text can be obtained by detecting the message issuing event.

S530: extracting one or more feature vectors included in the issued message text. In the present embodiment, the issued message text can be segmented into multiple text segments by detecting punctuation symbols so as to obtain a plurality of feature vectors; it is also possible not to segment the issued message text so as to obtain one feature vector.

S540: according to the feature vector(s), recognizing whether the issued message text to be detected matches one or more records in an advertisement feature database.

In the present embodiment, for each feature in the feature vector(s), it will be detected whether the feature appears in a preset advertisement feature database a plurality of times. After all of the features in the feature vector(s) are detected, proportion of the features in the feature vector(s), which appear in the advertisement feature database a plurality of times, to all of the features of the feature vector(s) is determined so as to determine whether the text to be detected matches a record in the advertisement feature database. In the present embodiment, a Redis advertisement feature database is used as the preset advertisement feature database. It is possible to obtain massive features by analyzing massive network advertisement texts (for example fetching junk information such as collected network advertisements) and obtain weights by accounting the numbers of the obtained respective features and make the features (Shingle) and the weights (Value) constitute the advertisement feature database.

S550: shielding the message issuing event, once recognizing the above match. Preferably, shielding the message issuing event is executed by the game server or the game client.

Further, the present invention, before acquiring the issued message text according to the message issuing event in the step S520, further includes: detecting whether a type of the message issuing event is a broadcast message event or a multicast message event. If not, then the process ends. If yes, then the issued message text is acquired according to the message issuing event.

Through the step S530 and the step S540 of the present invention, it is realized to recognize the advertisement features of the message issued in the network game by performing the similar text monitoring with a record in the advertisement feature database. Wherein the detailed flow of the step S530 is roughly the same as the steps S100, S200 and S300 as shown in FIG. 1, more specifically, is roughly the same as the steps S110, S120, S130, S200 and S300 as shown in FIG. 2; the detailed flow of the step S540 is roughly the same as the steps S400 as shown in FIG. 1, more specifically, is roughly the same as the steps S410-S490 as shown in FIG. 3, which will not be repeated here.

FIG. 6 illustrates a block diagram of a device for recognizing advertisement features of messages issued in a network game according to an embodiment of the present invention. The device includes a detection unit 610, a text acquisition unit 620, a feature vector extraction unit 630, a recognition unit 640, a shielding unit 650 and an advertisement feature database 660.

Wherein the detection unit 610 is configured to detect a message issuing event at a game client.

Specifically, when a message is issued at the game client, the detection unit 610 can detect a message issuing event. Further, the detection unit 610 can detect the message issuing event by detecting communication contents between the game server and the game client.

Further, the detection unit 610 is configured to, before the text acquisition unit 620 acquires the issued message text according to the message issuing event, detect whether a type of the message issuing event is a broadcast message event or a multicast message event. If not, then the process ends. If yes, then the text acquisition unit 620 acquires the issued message text according to the message issuing event.

The text acquisition unit 620 is configured to acquire an issued message text according to the message issuing event. It can be easily understood by those skilled in the art that, the text acquisition unit 620 can obtain the issued message text by detecting the message issuing event.

The feature vector extraction unit 630 is configured to extract one or more feature vectors included in the issued message text.

The recognition unit 640 is configured to, according to the feature vector(s), recognize whether the issued message text to be detected matches one or more records in the advertisement feature database 660. Preferably, the recognition unit 640 of the present embodiment is roughly the same as the detection unit 400 as shown in FIG. 4, which will not be repeated here.

A Redis advertisement feature database is used as the advertisement feature database 660 in the present embodiment. It is possible to obtain massive features by analyzing massive network texts (for example fetching junk information such as collected network advertisements) and obtain weights by accounting the numbers of the obtained respective features and make the features (Shingle) and the weights (Value) constitute the advertisement feature database.

The shielding unit 650 is configured to, shield the message issuing event, once the recognition unit recognizes the above match. The shielding unit 650 of the present embodiment is located at the game server or the game client executing the message issuing event.

More specifically, the feature vector extraction unit 630 of the present embodiment specifically includes a Chinese text acquisition sub-unit 631, a Pinyin text acquisition sub-unit 632 and a fingerprint acquisition sub-unit 633. Preferably, the Chinese text acquisition sub-unit 631, the Pinyin text acquisition sub-unit 632 and the fingerprint acquisition sub-unit 633 are roughly the same as the Chinese text acquisition unit 100, the Pinyin text acquisition unit 200 and the fingerprint acquisition unit 300 as shown in FIG. 4, respectively, which will not be repeated here.

Preferably, the device for recognizing advertisement features of messages issued in a network game of the present embodiment further includes an advertisement feature database updating unit 670.

The advertisement feature database updating unit 670 is configured to, when it is determined that the text to be detected matches a record in the advertisement feature database 660, for each feature in the feature vector, if it is detected that the feature exists in the advertisement feature database 660, increase the weight of this feature in the advertisement feature database 660 by 1. In other words, if the text to be detected matches a record in the advertisement feature database, the advertisement feature database 660 is updated, so that the update of the advertisement feature database 660 is realized.

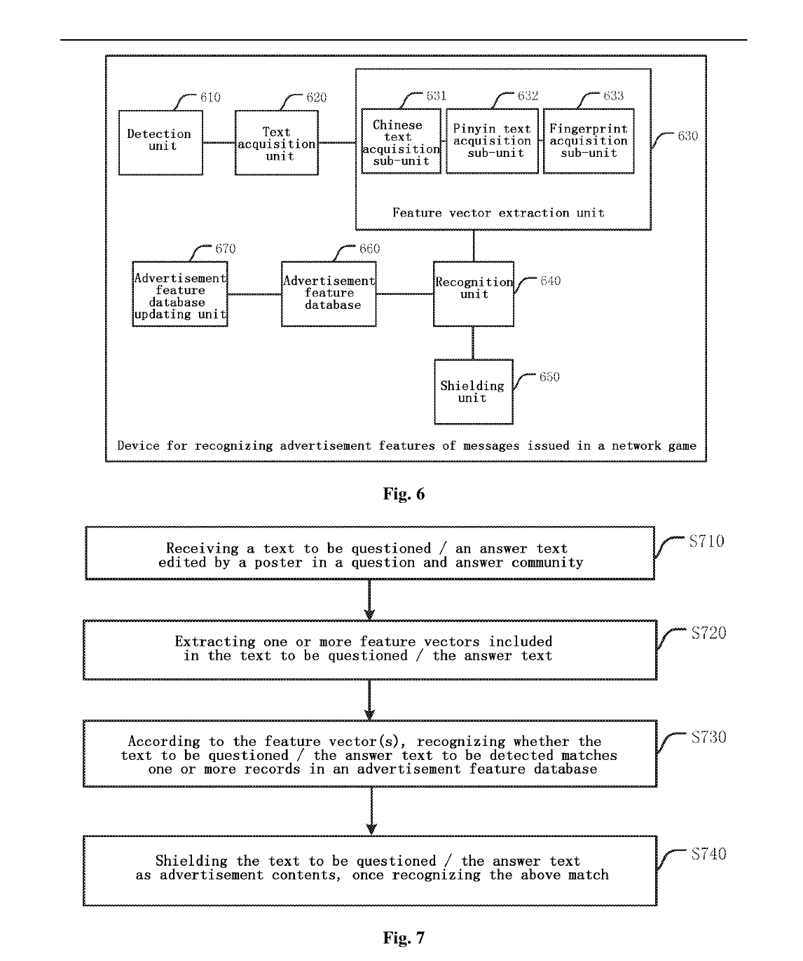

FIG. 7 illustrates a flowchart of a method for shielding advertisement contents in a question and answer community according to an embodiment of the present invention. The method includes the following steps S710, S720, S730 and S740.

S710: receiving a text to be questioned/an answer text edited by a poster in a question and answer community. It can be easily understood by those skilled in the art that the text to be questioned/the answer text can further be fetched and obtained by detecting an event in which a poster edits a text to be questioned/an answer text.

S720: extracting one or more feature vectors included in the text to be questioned/the answer text. In the present embodiment, the text to be questioned/the answer text can be segmented into multiple text segments by detecting punctuation symbols so as to obtain a plurality of feature vectors; it is also possible not to segment the text to be questioned/the answer text so as to obtain one feature vector.

S730: according to the feature vector(s), recognizing whether the text to be questioned/the answer text to be detected matches one or more records in an advertisement feature database.

In the present embodiment, for each feature in the feature vector(s), it will be detected whether the feature appears in a preset advertisement feature database a plurality of times. After all of the features in the feature vector(s) are detected, proportion of the features in the feature vector(s), which appear in the advertisement feature database a plurality of times, to all of the features of the feature vector(s) is determined, so as to determine whether the text to be questioned/the answer text matches a record in the advertisement feature database. In the present embodiment, a Redis advertisement feature database is used as the preset advertisement feature database. It is possible to obtain massive features by analyzing massive network advertisement texts (for example fetching junk information such as collected network advertisements) and obtain weights by accounting the numbers of the obtained respective features and make the features (Shingle) and the weights (Value) constitute the advertisement feature database.

S740: shielding the text to be questioned/the answer text as advertisement contents, once recognizing the above match.

Through the step S720 and the step S730 of the present invention, it is realized to recognize the advertisement in the text to be questioned/the answer text by performing the similar text monitoring with a record in the advertisement feature database. Wherein the detailed flow of the step S730 is roughly the same as the steps S100, S200 and S300 as shown in FIG. 1, more specifically, is roughly the same as the steps S110, S120, S130, S200 and S300 as shown in FIG. 2; the detailed flow of the step S740 is roughly the same as the steps S400 as shown in FIG. 1, more specifically, is roughly the same as the steps S410-S490 as shown in FIG. 3, which will not be repeated here.

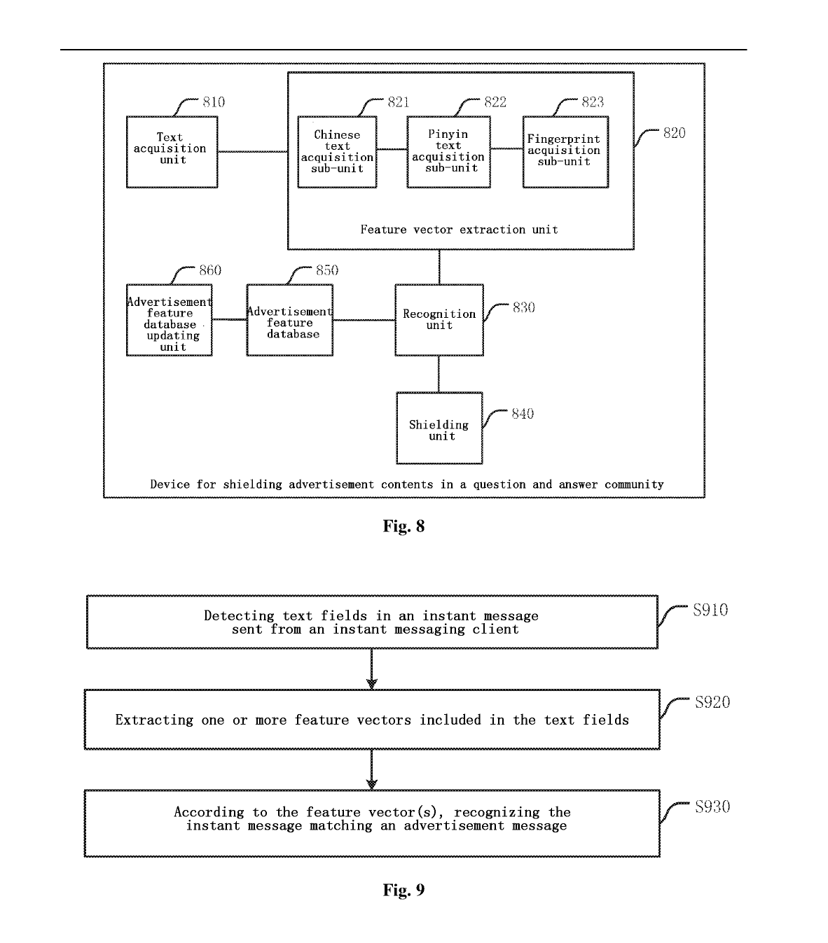

FIG. 8 illustrates a block diagram of a device for shielding advertisement contents in a question and answer community according to an embodiment of the present invention. The device includes a text acquisition unit 810, a feature vector extraction unit 820, a recognition unit 830, a shielding unit 840 and an advertisement feature database 850.

Wherein the text acquisition unit 810 is configured to receive a text to be questioned/an answer text edited by a poster in a question and answer community. It can be easily understood by those skilled in the art that, the text to be questioned/the answer text can further be fetched and obtained by detecting an event in which a poster edits a text to be questioned/an answer text.

The feature vector extraction unit 820 is configured to extract one or more feature vectors included in the text to be questioned/the answer text. In the present embodiment, the feature vector extraction unit 820 can segment the text to be questioned/the answer text into multiple text segments by detecting punctuation symbols so as to obtain a plurality of feature vectors; it is also possible not to segment the text to be questioned/the answer text so as to obtain one feature vector.

The recognition unit 830 is configured to, according to the feature vector(s), recognize whether the text to be questioned/the answer text matches one or more records in the advertisement feature database 850. Preferably, the recognition unit 830 of the present embodiment is roughly the same as the detection unit 400 as shown in FIG. 4, which will not be repeated here.

A Redis advertisement feature database is used as the advertisement feature database 850 in the present embodiment. It is possible to obtain massive features by analyzing massive network texts (for example fetching junk information such as collected network advertisements) and obtain weights by accounting the numbers of the obtained respective features and make the features (Shingle) and the weights (Value) constitute the advertisement feature database.

The shielding unit 840 is configured to shield the text to be questioned/the answer text as advertisement contents, once the recognition unit 830 recognizes the above match.

More specifically, the feature vector extraction unit 820 of the present embodiment specifically includes a Chinese text acquisition sub-unit 821, a Pinyin text acquisition sub-unit 822 and a fingerprint acquisition sub-unit 823. Preferably, the Chinese text acquisition sub-unit 821, the Pinyin text acquisition sub-unit 822 and the fingerprint acquisition sub-unit 823 are roughly the same as the Chinese text acquisition unit 100, the Pinyin text acquisition unit 200 and the fingerprint acquisition unit 300 as shown in FIG. 4, respectively, which will not be repeated here.

Preferably, the device for shielding advertisement contents in the question and answer community of the present embodiment further includes an advertisement feature database updating unit 860. The advertisement feature database updating unit 860 is configured to, when it is determined that the text to be detected matches a record in the advertisement feature database 850, for each feature in the feature vector, if it is detected that the feature exists in the advertisement feature database 850, increase the weight of this feature in the advertisement feature database 850 by 1. In other words, if the text to be detected matches a record in the advertisement feature database, the advertisement feature database 850 is updated, so that the update of the advertisement feature database 850 is realized.

FIG. 9 illustrates a flowchart of a method for recognizing advertisement messages in instant messaging according to an embodiment of the present invention. The method includes the following steps S910, S920 and S930.

S910: detecting text fields in an instant message sent from an instant messaging client.

In the present embodiment, non-text contents (such as pictures, videos and so on) can be filtered out from the instant message, so as to filter and obtain the text fields.

S920: extracting one or more feature vectors included in the text fields. In the present embodiment, the text fields can be segmented into multiple text segments by detecting punctuation symbols so as to obtain a plurality of feature vectors; it is also possible not to segment the text fields so as to obtain one feature vector.

S930: according to the feature vector(s), recognizing the instant message matching an advertisement message.

In the present embodiment, for each feature in the feature vector(s), it will be detected whether the feature appears in a preset advertisement feature database a plurality of times. After all of the features in the feature vector(s) are detected, proportion of the features in the feature vector(s), which appear in the advertisement feature database a plurality of times, to all of the features of the feature vector(s) is determined, so as to determine whether the instant message matches a record in the advertisement feature database. In the present embodiment, a Redis advertisement feature database is used as the preset advertisement feature database. It is possible to obtain massive features by analyzing massive network advertisement texts (for example fetching junk information such as collected network advertisements) and obtain weights by accounting the numbers of the obtained respective features, and make the features (Shingle) and the weights (Value) constitute the advertisement feature database.

Through the step S920 and the step S930 of the present invention, the advertisement in the instant message will be recognized by performing the similar text monitoring with a record in the advertisement feature database. Wherein the detailed flow of the step S920 is roughly the same as the steps S100, S200 and S300 as shown in FIG. 1, more specifically, is roughly the same as the steps S110, S120, S130, S200 and S300 as shown in FIG. 2; the detailed flow of the step S930 is roughly the same as the steps S400 as shown in FIG. 1, more specifically, is roughly the same as the steps S410-S490 as shown in FIG. 3, which will not repeated here.

Preferably, the present embodiment further includes: once recognizing that the instant message matches an advertisement message, shielding the instant message matching the advertisement message and/or identifying the instant message matching the advertisement message and the client which sent the instant message matching the advertisement message, and not forwarding any instant message send by this client within a predetermined time. Thereby a specific instant message will be shielded and/or management of banning to post on the client which sends the advertisement message will be realized.

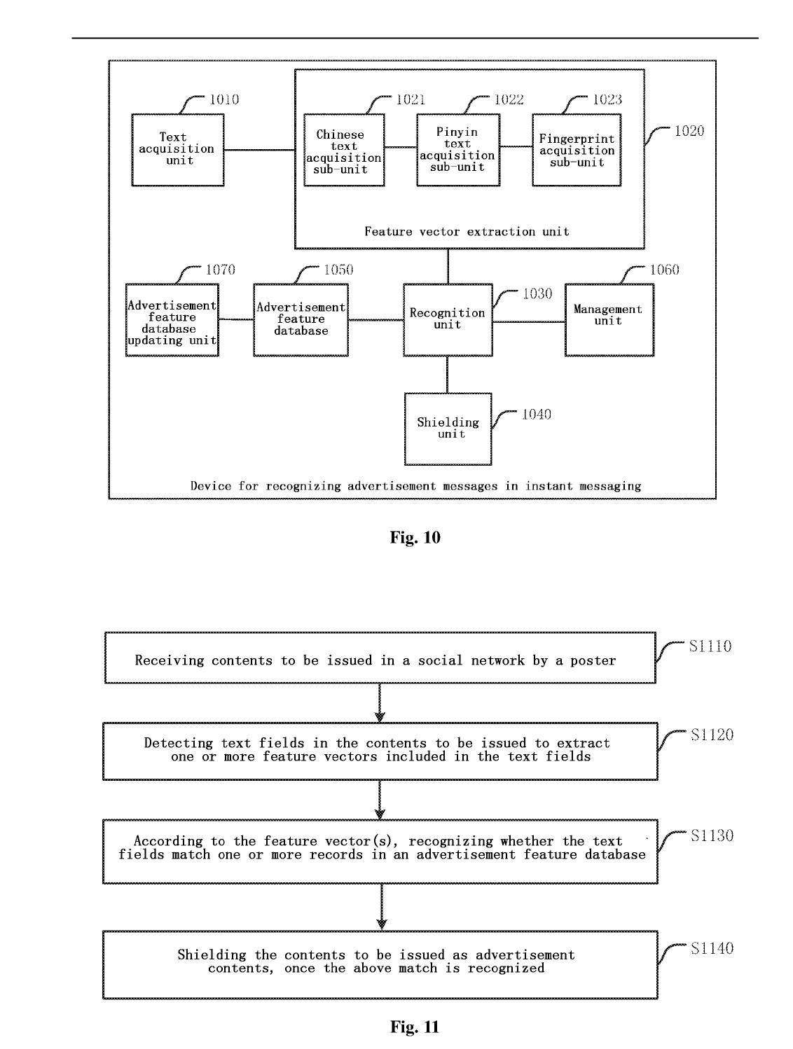

FIG. 10 illustrates a block diagram of a device for recognizing advertisement messages in instant messaging according to an embodiment of the present invention. The device includes a text acquisition unit 1010, a feature vector extraction unit 1020, a recognition unit 1030, a shielding unit 1040 and an advertisement feature database 1050.

The text acquisition unit 1010 is configured to detect text fields in an instant message sent from an instant messaging client. In the present embodiment, the feature vector extraction unit 1020 can filter out non-text contents such as pictures, videos and so on from the issued contents, so as to filter and obtain the text fields.

The feature vector extraction unit 1020 is configured to extract one or more feature vectors included in the text fields. In the present embodiment, the feature vector extraction unit 1020 can segment the text fields into multiple text segments by detecting punctuation symbols so as to obtain a plurality of feature vectors; it is also possible not to segment the text fields so as to obtain one feature vector.

The recognition unit 1030 is configured to, according to the feature vector(s), recognize the instant message matching an advertisement message. In the present embodiment, the recognition unit 1030 is configured to, according to the feature vector(s), determine whether the instant message matches a record in the advertisement feature database 1050. Preferably, the recognition unit 1030 of the present embodiment is roughly the same as the detection unit 400 as shown in FIG. 4, which will not be repeated here.

A Redis advertisement feature database is used as the advertisement feature database 1050 in the present embodiment. It is possible to obtain massive features by analyzing massive network texts (for example fetching junk information such as collected network advertisements) and obtain weights by accounting the numbers of the obtained respective features and make the features (Shingle) and the weights (Value) constitute the advertisement feature database.

Preferably, the device for recognizing advertisement messages in instant messaging of the present embodiment further includes the shielding unit 1040 which is configured to, shield the instant message matching the advertisement message, once the recognition unit 1030 recognizes the above match. Further, the device for recognizing advertisement messages in instant messaging of the present embodiment further includes a management unit 1060 which is configured to, once the recognition unit 1030 recognizes the instant message matching the advertisement message, identify the instant message matching the advertisement message and the client which sent the instant message matching the advertisement message, and not to forward any instant message send by this client within a predetermined time, so that management of banning to post on the client which sends advertisement will be realized. More preferably, the device for recognizing advertisement messages in instant messaging of the present embodiment further includes an advertisement feature database updating unit 1070. The advertisement feature database updating unit 1070 is configured to, when it is determined that the instant message matches a record in the advertisement feature database 1050, for each feature in the feature vector, if it is detected that the feature exists in the advertisement feature database 1050, increase the weight of this feature in the advertisement feature database 1050 by 1. In other words, if the instant message matches a record in the advertisement feature database, the advertisement feature database 1050 is updated, so that the update of the advertisement feature database 1050 is realized.

Specifically, the feature vector extraction unit 1020 of the present embodiment includes a Chinese text acquisition sub-unit 1021, a Pinyin text acquisition sub-unit 1022 and a fingerprint acquisition sub-unit 1023. Preferably, the Chinese text acquisition sub-unit 1021, the Pinyin text acquisition sub-unit 1022 and the fingerprint acquisition sub-unit 1023 are roughly the same as the Chinese text acquisition unit 100, the Pinyin text acquisition unit 200 and the fingerprint acquisition unit 300 as shown in FIG. 4, respectively, which will not be repeated here.

FIG. 11 illustrates a flowchart of a method for processing contents issued in a social network according to an embodiment of the present invention. The method includes the following steps S1110, S1120, S1130 and S1140.

S1110: receiving contents to be issued in a social network by a poster.

The social network includes at least one of the following: Weibo, Blog, forums, Moments.

S1120: detecting text fields in the contents to be issued to extract one or more feature vectors included in the text fields. In the present embodiment, non-text contents can be filtered out from issued contents and the text fields are screened and obtained. Further, the text fields can be segmented into multiple text segments by detecting punctuation symbols so as to obtain a plurality of feature vectors; it is also possible not to segment the text fields so as to obtain one feature vector.

S1130: according to the feature vector(s), recognizing whether the text fields match one or more records in an advertisement feature database.

In the present embodiment, for each feature in the feature vector(s), it will be detected whether the feature appears in a preset advertisement feature database a plurality of times. After all of the features in the feature vector(s) are detected, proportion of the features in the feature vector(s), which appear in the advertisement feature database a plurality of times, to all of the features of the feature vector(s) is determined, so as to determine whether the text fields matches a record in the advertisement feature database. In the present embodiment, a Redis advertisement feature database is used as the preset advertisement feature database. It is possible to obtain massive features by analyzing massive network advertisement texts (for example fetching junk information such as collected network advertisements) and obtain weights by accounting the numbers of the obtained respective features, and make the features (Shingle) and the weights (Value) constitute the advertisement feature database.

S1140: shielding the contents to be issued as advertisement contents, once the above match is recognized.

Through the step S1120 and the step S1130 of the present invention, the advertisement in the contents to be issued will be recognized by performing the similar text monitoring with a record in the advertisement feature database. Wherein the detailed flow of the step S1120 is roughly the same as the steps S100, S200 and S300 as shown in FIG. 1, more specifically, is roughly the same as the steps S110, S120, S130, S200 and S300 as shown in FIG. 2; the detailed flow of the step S1130 is roughly the same as the steps S400 as shown in FIG. 1, more specifically, is roughly the same as the steps S410-S490 as shown in FIG. 3, which will not repeated here.

FIG. 12 illustrates a block diagram of a device for processing contents issued in a social network according to an embodiment of the present invention. The device includes a content acquisition unit 1210, a feature vector extraction unit 1220, a recognition unit 1230, a shielding unit 1240 and an advertisement feature database 1250.

The content acquisition unit 1210 is configured to receive contents to be issued in a social network by a poster.

The content acquisition unit is configured to receive contents to be issued by a poster in at least one of the following social networks: Weibo, Blog, forums, Moments.

The feature vector extraction unit 1220 is configured to detect text fields in the contents to be issued to extract one or more feature vectors included in the text fields. In the present embodiment, the feature vector extraction unit 1220 can filter out non-text contents such as pictures, video and so on from issued contents and screen and obtain the text fields. Further, the feature vector extraction unit 1220 can segment the text fields into multiple text segments by detecting punctuation symbols so as to obtain a plurality of feature vectors; it is also possible not to segment the text fields so as to obtain one feature vector.

The recognition unit 1230 is configured to, according to the feature vector(s), recognize whether the text fields match one or more records in the advertisement feature database 1250. Preferably, the recognition unit 1230 of the present embodiment is roughly the same as the detection unit 400 as shown in FIG. 4, which will not be repeated here.

A Redis advertisement feature database is used as the advertisement feature database 1250 in the present embodiment. It is possible to obtain massive features by analyzing massive network texts (for example fetching junk information such as collected network advertisements) and obtain weights by accounting the numbers of the obtained respective features, and make the features (Shingle) and the weights (Value) constitute the advertisement feature database.

The shielding unit 1240 is configured to shield the contents to be issued as advertisement contents, once the recognition unit 1230 recognizes the above match.

Preferably, the device for processing contents issued in a social network of the present embodiment further includes an advertisement feature database updating unit 1260. The advertisement feature database updating unit 1260 is configured to, when it is determined that the text fields match a record in the advertisement feature database 1250, for each feature in the feature vector, if it is detected that the feature exists in the advertisement feature database 1250, increase the weight of this feature in the advertisement feature database 1250 by 1. In other words, if the text fields match a record in the advertisement feature database, the advertisement feature database 1250 is updated, so that the update of the advertisement feature database 1250 is realized.

Specifically, the feature vector extraction unit 1220 of the present embodiment specifically includes a Chinese text acquisition sub-unit 1221, a Pinyin text acquisition sub-unit 1222 and a fingerprint acquisition sub-unit 1223. Preferably, the Chinese text acquisition sub-unit 1221, the Pinyin text acquisition sub-unit 1222 and the fingerprint acquisition sub-unit 1223 are roughly the same as the Chinese text acquisition unit 100, the Pinyin text acquisition unit 200 and the fingerprint acquisition unit 300 as shown in FIG. 4, respectively, which will not be repeated here.

The respective components of the embodiments of the present invention can be implemented in hardware, or implemented in a software module running on one or more processor, or implemented in combination thereof. It should be understood by those skilled in the art that, in practice a microprocessor or a digital signal processor (DSP) can be used to implement some or all functions of some or all components in a similar text detection device, a device for recognizing advertisement features of issued messages in a network game, a device for shielding advertisement contents in a question and answer community, a device for recognizing advertisement messages in instant message and a device for processing contents issued in a social network according to the embodiments of the present application. The present application can also be implemented as a device or device program (e.g., a computer program and a computer program product) for executing some of all of the method described here. Such a program for implementing the present application can be stored on a computer readable medium or can have a form of one or more signal. Such a signal can be downloaded from an Internet website or provided on a carrier signal or provided in any other form.

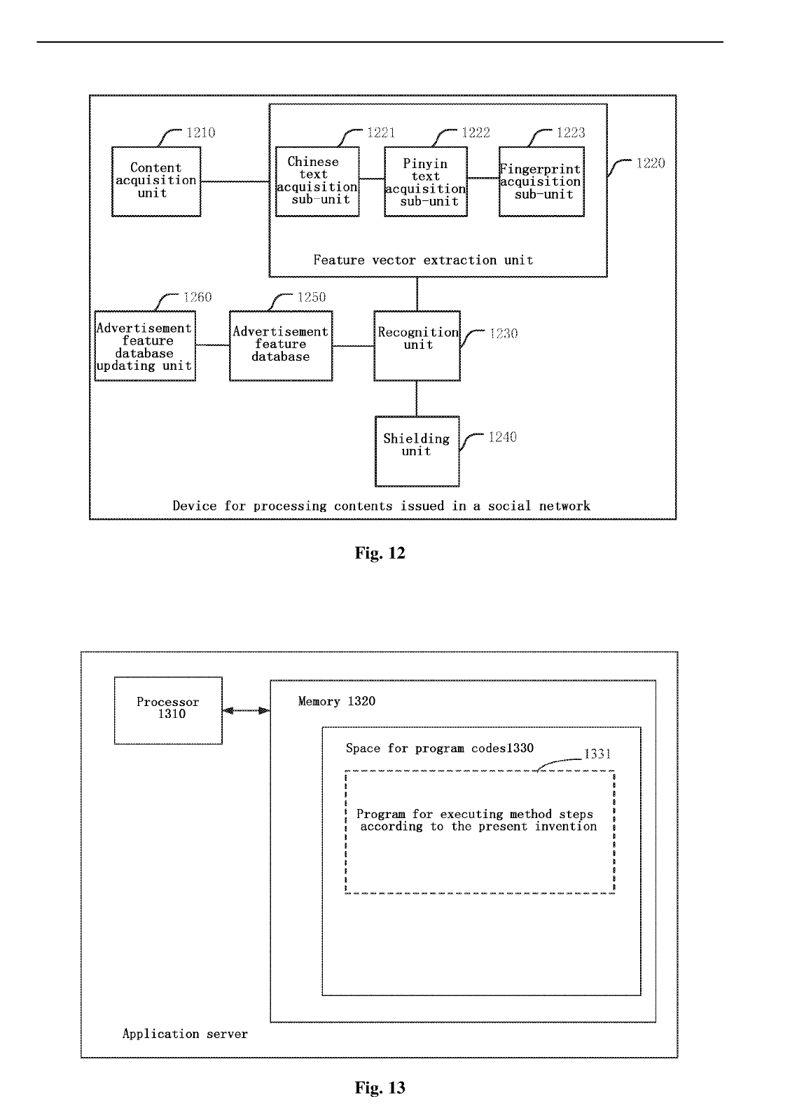

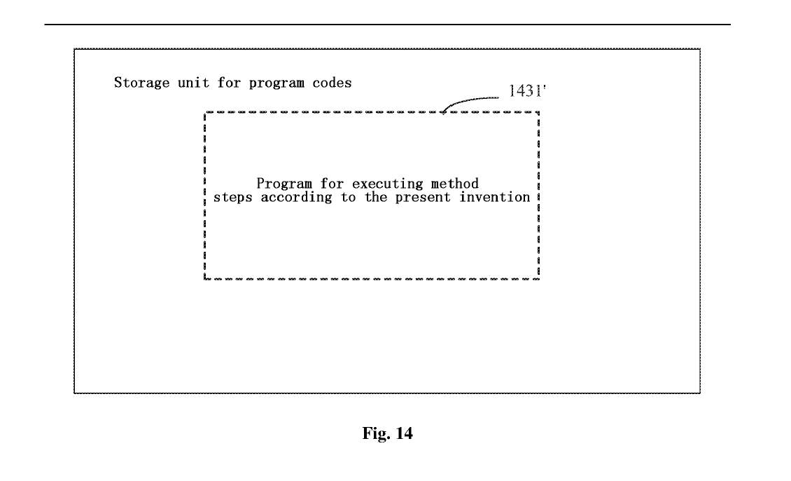

For example, FIG. 13 illustrates a block diagram of a server, such as an application server, for executing a similar text detection method, a method for recognizing advertisement features of issued messages in a network game, a method for shielding advertisement contents in a question and answer community, a method for recognizing advertisement messages in instant messaging and a method for processing contents issued in a social network according to the present invention. The application server traditionally includes a processor 1310 and a computer program product or a computer readable medium in a form of a memory 1320. The memory 1320 can be an electronic memory such as a flash memory, an EEPROM (Electrically Erasable Programmable Read Only Memory), an EPROM, a hard disk or a ROM or the like. The memory 1320 has a storage space 1330 for program codes 1331 for executing any method steps in the above method. For example, the storage space 1330 for the program codes can include the respective program codes 1331 for respectively implementing various steps in the above method. These program codes can be read out from or written into one or more computer program products. These computer program products include program code carriers such as a hard disk, a compact disk (CD), a memory card or a floppy disk. Such computer program products are generally portable or fixed storage units as described with reference to FIG. 14. The storage units can have storage sections, storage spaces, etc. arranged similar to those of the memory 1420 in the application server of FIG. 13. The program codes can be compressed for example in a suitable format. Generally, the storage units include computer readable codes 1431′, that is, codes that can be read by a processor for example such as processor 1310. When these codes are run by the server, the server is caused to execute respective steps in the above described method.

“One embodiment”, “an embodiment” or “one or more embodiment” referred to as in the specification means, that a specific feature, structure or characteristic described in connection with the embodiments is included in at least one embodiment of the present invention. Moreover, it should be noted that, a word example of “in one embodiment” here does not necessarily all refer to the same embodiment.

In the specification provided here, a number of specific details are explained. However, it should be understood that, the embodiments of the present invention can be practiced without these specific details. In some embodiments, a method, structure and technology known well have not been illustrated in detail, so as not to obscure the understanding of the specification.

It should be noted that, the above described embodiments are used for explaining the present invention, rather than limiting the present invention, and an alternative embodiment can be designed by those skilled in the art without departing from the scope of the appended claims. In the claims, any reference symbol positioned between parentheses should not be considered the limiting of the claims. The word “include” does not exclude the existence of an element or a step that is not described in the claims. The word “a” or “an” positioned before an element does not exclude the existence of a plurality of such element. The present invention can be implemented by way of a hardware including several different elements and by way of a computer suitably programmed. In a unit claim enumerating several devices, several of these devices can be specifically implemented by the same hardware. The use of the word “first”, “second” and “third”, etc. does not represent any sequence. These words can be construed as a name.

Furthermore, it also should be noted that, the expressions used in the specification are principally selected for the purpose of readability and teaching, are not selected for interpreting or limiting the subject of the present invention. Therefore, many modifications and alteration are all obvious for those ordinary skilled in the art, without departing from the scope and spirit of the appended claims. For the scope of the present invention, the disclosure of the present invention is illustrative, not limiting and the scope of the present invention is limited by the appended claims.

1. A similar text detection device, wherein the device includes one or more non-transitory computer readable medium configured to store computer-executable instructions, and at least one processor to execute the instructions to cause:
processing a text to acquire a Chinese text;
converting Chinese characters in the acquired Chinese text into Pinyin so as to obtain a Pinyin text;
extracting features of the Pinyin text and form the extracted features into a feature vector of the Pinyin text;
according to the feature vector, determining whether the text to be detected matches a record in a database.

2-3. (canceled)

4. A device for recognizing advertisement messages in instant messaging, wherein the device includes one or more non-transitory computer readable medium configured to store computer-executable instructions, and at least one processor to execute the instructions to cause:
detecting text fields in an instant message sent from an instant messaging client;
extracting one or more feature vectors included in the text fields;
according to the feature vector(s), recognizing the instant message matching an advertisement message.

5. (canceled)

6. A similar text detection method, wherein the method includes the following steps:
processing a text to be detected to acquire a Chinese text;
converting Chinese characters in the acquired Chinese text into Pinyin to obtain a Pinyin text;
extracting features of the Pinyin text and forming the extracted features into a feature vector of the Pinyin text;
determining, according to the feature vector, whether the text to be detected matches a record in a database.

7. The method according to claim 6, wherein the determining whether the text to be detected matches the record in the database includes:
detecting, for each feature of the feature vector, whether the feature appears in the database multiple times;
determining whether proportion of the features in the feature vector, which appear in the database multiple times, to all of the features of the feature vector reaches a first threshold, if so, then determining that the text to be detected matches the record in the database, otherwise does not match.

8. The method according to claim 6, wherein detecting whether the feature appears in the database multiple times includes:
searching the database to find whether the feature exists, if the feature exists, then further looking for weight of the feature, and if the weight of the feature is larger than or equal to a second threshold, then determining that the feature appears in the database multiple times.

9. The method according to claim 6, wherein when determining that the text to be detected matches a record in the database, the method further includes:
for each feature in the feature vector, if it is detected that the feature exists in the database, increasing the weight of this feature in the database by 1.

10. The method according to claim 6, wherein:
for each feature in the feature vector, before, detecting whether the feature exists in the database, determining whether the text to be detected matches a record in the database further includes:
determining whether the number of the features in the feature vector is smaller than a third threshold, if so, then determining the text to be detected does not match the record in the database and ending the determination operation, otherwise for each feature in the feature vector, detecting whether the feature appears in the database multiple times.

11. The method according to claim 6, wherein processing the text to acquire the Chinese text specifically includes:
performing data cleaning operation on the text to convert contents in the text into regular characters; converting the Pinyin into Chinese characters; and reserving commonly used Chinese characters.

12. The method according to claim 6, wherein, performing the data cleaning operation on the text specifically includes:
recognizing and discarding HTML marks, converting traditional Chinese characters into simplified Chinese characters, converting full-width characters into half-width characters, converting uppercase English letters into lowercase English letters and recognizing and discarding url;
the converting the Pinyin in the text into Chinese characters specifically includes: converting the Pinyin in the text into Chinese characters by using a bidirectional maximum matching algorithm and if one Pinyin corresponds to a plurality of Chinese characters, selecting any one from the corresponding plurality of Chinese characters;
the reserving the commonly used Chinese characters specifically includes: filtering the text by using the commonly used Chinese characters in the GBK coding table, discarding all characters which do not belong to the commonly used Chinese characters.

13. The method according to claim 6, wherein converting Chinese characters in the acquired Chinese text into the Pinyin to obtain the Pinyin text specifically includes:
using a Pinyin-Chinese character comparison table to convert each of the Chinese characters into a corresponding Pinyin string, so as to obtain the Pinyin text.

14. The method according to claim 6, wherein extracting the features of the Pinyin text and forming the extracted features into the feature vector of the Pinyin text specifically includes:
extracting the features of the Pinyin text with a single Chinese character as segmentation granularity and forming the extracted features into the feature vector of the Pinyin text by using a Vector Space Model.

15-62. (canceled)

63. The device according to claim 4, wherein the processor further executes the computer-executable instructions to cause:
shielding the instant message matching the advertisement message, when the instant message matching an advertisement message is recognized.

64. The device according to claim 4, wherein, when the instant message matching an advertisement message is recognized, the instant message matching the advertisement message and the client which sent the instant message matching the advertisement message are identified, and the instant message sent by this client are not forwarded within a predetermined time.

65. The device according to claim 4, wherein according to the feature vector(s), recognizing the instant message matching the advertisement message further includes:
according to the feature vector(s), determining whether the instant message matches a record in an advertisement feature database.

66. The device according to claim 65, wherein according to the feature vector(s), determining whether the instant message matches the record in the advertisement feature database includes:
for each feature in the feature vector(s), detecting whether the feature appears in the advertisement feature database multiple times; and
determining whether proportion of the features in the feature vector(s), which appear in the advertisement feature database multiple times, to all of the features of the feature vector(s) reaches a first threshold and if so, then determining that the instant message matches the record in the advertisement feature database, otherwise does not match.

67. The device according to claim 66, wherein detecting whether the feature appears in the advertisement feature database multiple times includes:
searching the advertisement feature database to find whether the feature exists, if the feature exists, then further looking for weight of the feature, and if the weight of the feature is larger than or equal to a second threshold, then determining that the feature appears in the advertisement feature database multiple times.

68. The device according to claim 65, wherein the processor further executes the computer-executable instructions to cause:
when determining that the instant message matches the record in the advertisement feature database, for each feature in the feature vector, if it is detected that the feature exists in the advertisement feature database, increasing the weight of this feature in the advertisement feature database by 1.

69. The device according to claim 65, for each feature in the feature vector, before, detecting whether the feature exists in the advertisement feature database, determining whether the instant message matches the record in the advertisement feature database further includes:
determining whether the number of the features in the feature vector is smaller than a third threshold, if so, then the instant message does not match the record in the advertisement feature database and ending the determination operation, otherwise for each feature in the feature vector, detecting whether the feature appears in the advertisement feature database multiple times.

70. The device according to claim 4, wherein extracting the one or more feature vectors included in the text fields includes:
processing the text fields to acquire the Chinese text;
converting Chinese characters in the acquired Chinese text into Pinyin to obtain the Pinyin text; and
extracting features of the Pinyin text and forming the extracted features into a feature vector of the Pinyin text.

71. The device according to claim 70, wherein processing the text fields to acquire the Chinese text includes:
performing data cleaning operation on the text fields to convert contents in the text fields into regular characters;
converting the Pinyin into Chinese characters; and
reserving commonly used Chinese characters.
